(19) United States
(12) Patent Application Publication
(10) Pub. No.: US 2008/0297582 A1
(43) Pub. Date: Dec. 4, 2008

(54) THERMAL PRINTING APPARATUS AND PRINTING METHOD THEREOF

(76) Inventors: Ming-Jiun Hung, Tai-Chung City (TW); Chih-Wei Huang, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/754,365

(22) Filed: May 28, 2007

(51) Int. Cl. B41J 2/00

(52) U.S. Cl. 347/188

(57) ABSTRACT

The present invention discloses a thermal printing apparatus and printing method thereof. The thermal printing apparatus includes a memory unit and a control unit. The method of the present invention includes storing at least a predetermined control mapping table, the predetermined control mapping table for recording control parameter settings of a thermal print head corresponding to different image gray levels under a predetermined power value; calculating an actual power value of the thermal print head; determining a target control mapping table according to the actual power value, the predetermined power value, and the predetermined control mapping table; and driving the thermal print head to print according to the target control mapping table.

### BACKGROUND OF THE INVENTION

1. Field of the Invention

The present invention relates to a thermal printing apparatus and method thereof, and more particularly, to a thermal printing apparatus and method thereof for compensating output energy of a thermal print head (TPH) by adjusting an energy/image gray-level mapping table.

2. Description of the Prior Art

A printing color concentration of a thermal sublimation (or thermal transfer) printer is determined by the energy (i.e. the product of power and printing time) of a thermal print head (TPH) during printing. Therefore, it is necessary to let the TPH have the same power during a printing time if the printing color concentration of the thermal sublimation printer is to be controlled stably.

In general, the power of the TPH during the printing operation is determined by a resistance value of the TPH and an input driving voltage. Since the resistance value of the TPH has a +/−10% error range when the TPH is manufactured, however, the driving voltage of the TPH has to be adjusted to fit the different mean resistance values of the TPH in order for every TPH to have the same power during printing.

In a conventional thermal sublimation printer, a DC-to-DC power converter and a voltage divider are coupled to the power input terminal of the TPH in order to adjust the driving voltage of the TPH. Adjusting the resistance of the voltage divider changes the driving voltage of the TPH, thus ensuring every TPH has the same or similar power during the printing operation.

The prior art utilizes a mechanical variable resistor coupled to a voltage feedback loop of the DC-to-DC power converter in order to adjust the driving voltage of the TPH. Please refer to FIG. 1. FIG. 1 shows a simplified block diagram of a thermal printing apparatus 100 according to the prior art. As shown in FIG. 1, the thermal printing apparatus 100 includes a TPH 102, a voltage divider 104, a DC power 106, and a DC to DC regulator 108, wherein the voltage divider 104 includes a first resistor R1, a second resistor R2, and a mechanical variable resistor VR1.

In the conventional design mentioned above, the resistance of the mechanical variable resistor can only be adjusted by hand. It is not only easy to generate errors due to the adjustments done by hand, but also reduces the production rate of the product in the production line, and increases the cost of labor. In addition, if the resistance of the mechanical variable resistor is shifted from an ideal resistance because of the component aging or vibration, then the driving voltage of the TPH will be shifted accordingly. In other words, the printing color concentration of the thermal sublimation printer will be affected and result in bad printing image quality. The other main disadvantages are that the cost of using the power converter is very expensive, and there is a power converting loss of the power converter.

In addition, the other prior arts utilize a voltage regulator and a current diode to control the driving voltage of the TPH, such as the U.S. Pat. No. 4,573,058. However, this conventional design also has a disadvantage of high cost, and the effect of this conventional design is not good enough due to the utilized current diode thereof having a large inaccuracy itself. In addition, the technique disclosed by the U.S. Pat. No. 5,745,146 also has a disadvantage of high cost, since the output impedance of the utilized analog-to-digital converter (ADC) thereof is not high enough, and it is necessary to utilize an amplifier having a high output impedance additionally to measure the dividing voltage value of the voltage divider 104. In addition, this conventional technique can only be applied in a bar code printer. In other words, this conventional design can only print a document in black and white colors.

### SUMMARY OF THE INVENTION

It is therefore one of the objectives of the present invention to provide a thermal printing apparatus and method thereof for compensating output energy of a thermal print head (TPH) by adjusting an energy/image gray-level mapping table to solve the above problems.

According to an embodiment of the present invention, a printing method of a thermal printing apparatus is disclosed. The printing method comprises: storing at least a predetermined control mapping table, the predetermined control mapping table for recording control parameter settings of a thermal print head corresponding to different image gray levels under a predetermined power value; calculating an actual power value of the thermal print head; determining a target control mapping table according to the actual power value, the predetermined power value, and the predetermined control mapping table; and driving the thermal print head to print according to the target control mapping table.

According to an embodiment of the present invention, a thermal printing apparatus is further disclosed. The thermal printing apparatus comprises a memory unit and a control unit. The memory unit is utilized for storing at least a predetermined control mapping table, the predetermined control mapping table for recording control parameter settings of a thermal print head corresponding to different image gray levels under a predetermined power value. The control unit is coupled to the memory unit and utilized for calculating an actual power value of the thermal print head, and determining a target control mapping table according to the actual power value, the predetermined power value, and the predetermined control mapping table, and driving the thermal print head to print according to the target control mapping table.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a thermal printing apparatus according to the prior art.

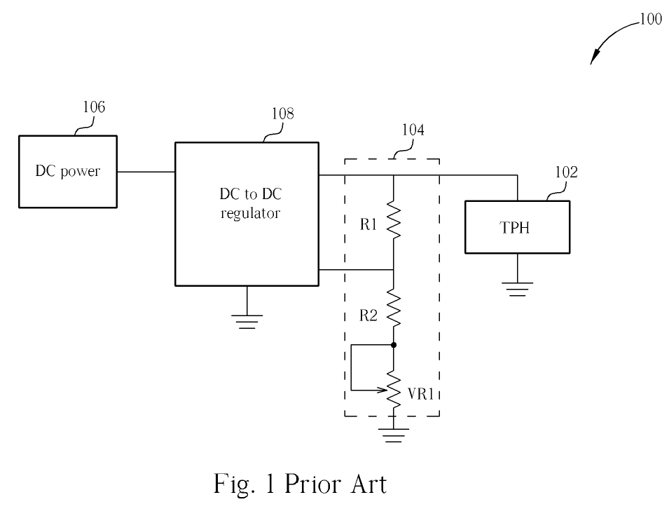

FIG. 2 shows a simplified block diagram of a thermal printing apparatus according to an embodiment of the present invention.

FIG. 3 shows a Gaussian distribution diagram of the power value of a thermal print head (TPH) according to an embodiment of the present invention.

FIG. 4 shows two candidate energy/image gray-level mapping tables according to an embodiment of the present invention.

FIG. 5 shows a Gaussian distribution diagram of the power value of a TPH and an actual power value according to an embodiment of the present invention.

FIG. 6 shows a simplified diagram of adjusting a predetermined energy/image gray-level mapping table according to an energy compensation parameter in order to determine a target energy/image gray-level mapping table.

FIG. 7 shows a Gaussian distribution diagram of the power value of a TPH and another actual power value according to an embodiment of the present invention.

FIG. 8 shows a simplified diagram of adjusting another predetermined energy/image gray-level mapping table according to another energy compensation parameter in order to determine another target energy/image gray-level mapping table.

FIG. 9 is a flowchart showing an exemplary method for controlling output energy of a TPH according an embodiment of the present invention.

### DETAILED DESCRIPTION

Certain terms are used throughout the following description and claims to refer to particular components. As one skilled in the art will appreciate, hardware manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

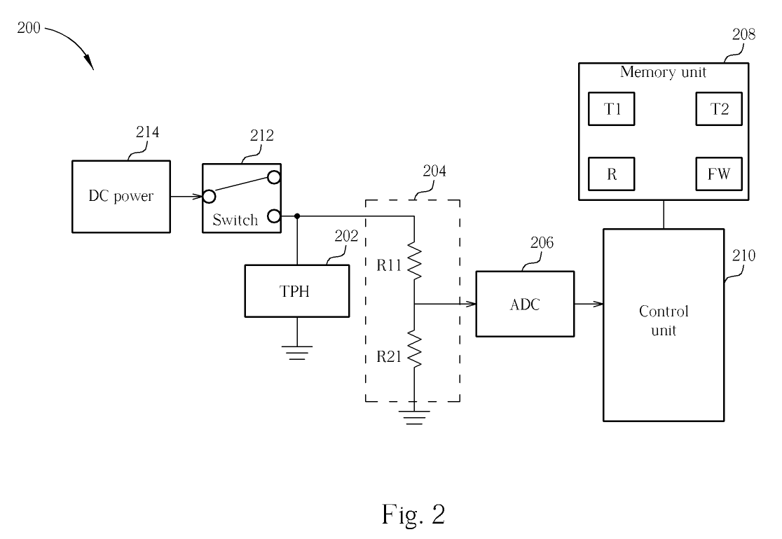

Please refer to FIG. 2. FIG. 2 shows a simplified block diagram of a thermal printing apparatus 200 according to an embodiment of the present invention. As shown in FIG. 2, the thermal printing apparatus 200 includes a thermal print head (TPH) 202, a voltage divider 204, an analog-to-digital converter (ADC) 206, a memory unit 208, a control unit 210, a switch 212, and a DC power 214, wherein the voltage divider 204 includes a first resistor R11 and a second resistor R21. Please note that the number of resistors included by the voltage divider 204 is only an illustration, and it is not a limitation of the present invention.

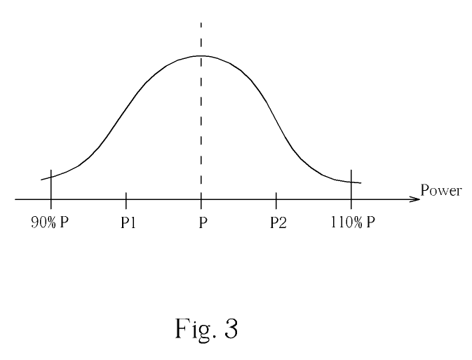

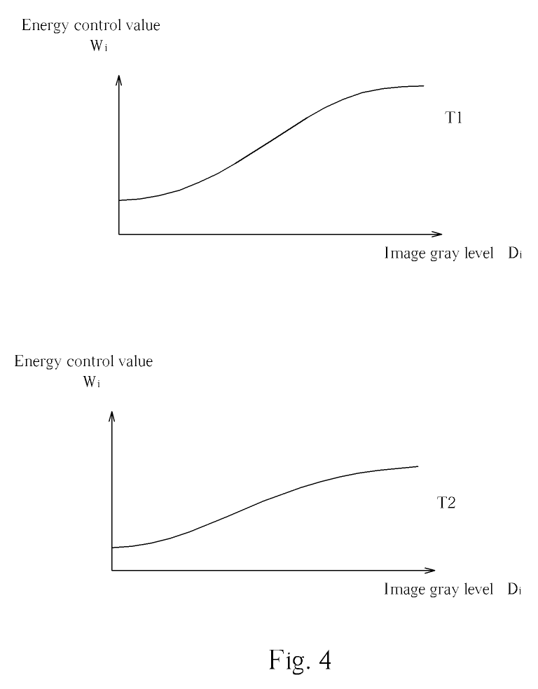

In general, a resistance value of the TPH 202 manufactured in a product line has a Gaussian distribution within a specific range (such as a +/−10% error range of a standard resistance value). In other words, a power value of the TPH 202 manufactured in the product line has the Gaussian distribution within a specific range (such as a +/−10% error range of a power value P), as shown in FIG. 3. FIG. 3 shows a Gaussian distribution diagram of the power value of the TPH 202. In an embodiment of the present invention method, at least a candidate energy/image gray-level mapping table will be stored in the memory unit 208 first according to the distribution range of the power value of the TPH 202. Two candidate energy/image gray-level mapping tables T1 and T2 (shown in FIG. 4) will be presented for an illustration in the following paragraphs without affecting the technical disclosure of the present invention. In addition, a firmware program FW and a resistance value R of the TPH 202 are further stored in the memory unit 208. The candidate energy/image gray-level mapping tables T1 corresponds to a standard power value P1, and the candidate energy/image gray-level mapping tables T2 corresponds to another standard power value P2. In addition, as shown in FIG. 4, Wi is an energy control value corresponding to a image gray level Di, and utilized for controlling the heating time period and/or the heating number of times of the TPH 202 in order to exert a specific heating energy upon a ribbon. In other words, each energy control value will correspond to a heating energy equivalently. For example, each image gray level is represented by 8 bits, and therefore i=1, 2, 3, . . . , 256, and each energy control value is represented by 16 bits. Therefore, each 8-bit image gray level can be further transformed to a 16-bit energy control value through the assistance of the energy/image gray-level mapping table. Then it is practicable to drive the TPH to exert the required heating energy upon the ribbon according to the energy control value and a predetermined heating scheme. Please note that the amount of the required storing energy/image gray-level mapping table is not limited in the present invention method, and the above description is only an embodiment for illustration.

Next, the control unit 210 executes the firmware program FW to calculate an actual voltage value of the TPH 202 according to the dividing voltage value of the voltage divider 204. In this embodiment, the present invention method utilizes the voltage divider 204 to generate a detecting voltage value according to the actual driving voltage value of the TPH 202. The method then utilizes the ADC 206 to perform an analog-to-digital converting operation on the detecting voltage to generate a detecting voltage value, and determine the actual voltage value of the TPH 202 according to the detecting voltage value. Next, the control unit 210 executes the firmware program FW to read the resistance value R of the TPH 202 from the memory unit 208, and calculates an actual power value Pa of the TPH 202 according to the resistance value R and the actual voltage value of the TPH 202.

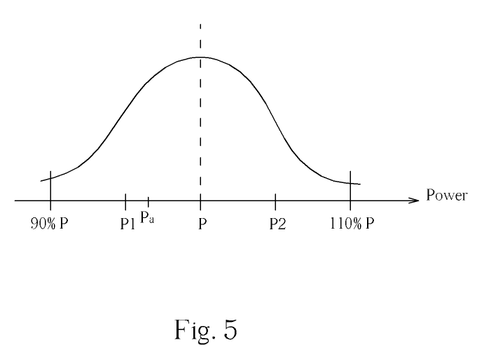

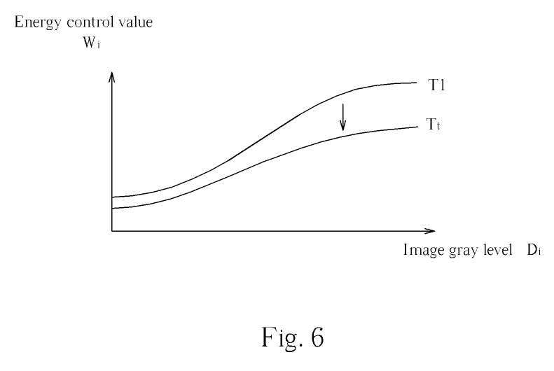

Next, the control unit 210 executes the firmware program FW to select one of the candidate energy/image gray-level mapping tables T1 and T2 as a predetermined energy/image gray-level mapping table from the plurality of candidate energy/image gray-level mapping tables according to the actual power value Pa of the TPH 202. For example, if the actual power value Pa of the TPH 202 is closer to the standard power value P1 (as shown in FIG. 5), then the control unit 210 will select the candidate energy/image gray-level mapping table T1 corresponding to the standard power value P1 as the predetermined energy/image gray-level mapping table. Then, the control unit 210 executes the firmware program FW to determine an energy compensation parameter A according to the standard power value P1 of the candidate energy/image gray-level mapping table T1 and the actual power value Pa of the TPH 202, wherein the energy compensation parameter A=P1/Pa. In this embodiment, since Pa is greater than P1, the energy compensation parameter A is less than 1. Next, the control unit 210 executes the firmware program FW to adjust the predetermined energy/image gray-level mapping table T1 according to the energy compensation parameter A in order to generate a target energy/image gray-level mapping table Tt. In the target energy/image gray-level mapping table Tt, an energy control value Wi′=A*Wi; in other words, the energy control value Wi′ will be less than Wi under a condition of the same image gray level (as shown in FIG. 6). Next, the control unit 210 executes the firmware program FW to drive the TPH 202 to print according to the target energy/image gray-level mapping table Tt. In this embodiment, the present invention method mainly utilizes the control unit 210 to execute the firmware program FW to control the output heating energy of the TPH 202 during the printing operation via controlling the turned-on and turned-off statuses of the switch 212. In this way, even under the condition of the actual power value Pa of the TPH 202 being higher than the standard power value P1, adopting the adjusted energy/image gray-level mapping table can still make the TPH 202 generate a standard energy value corresponding to the standard power value P1. Similarly, when the actual power value Pa of the TPH 202 is closer and less than the standard power value P1, it is also practicable to use the above method to tune the energy/image gray-level mapping table for controlling the TPH 202 to generate a standard energy value corresponding to the standard power value P1, and the detail is omitted for the sake of brevity.

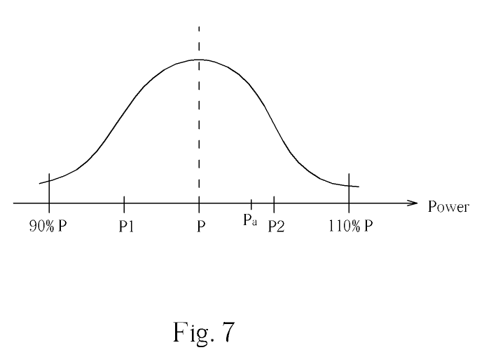

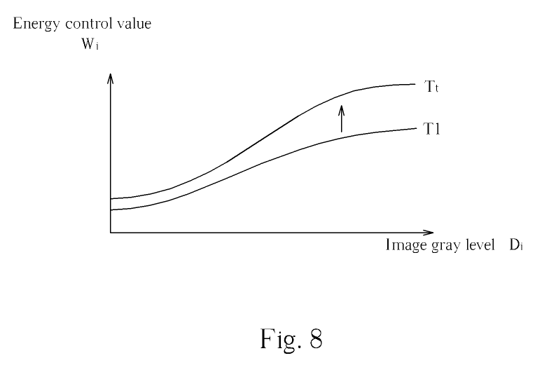

On the other hand, if the actual power value Pa of the TPH 202 is closer to the standard power value P2 (as shown in FIG. 7), then the control unit 210 will select the candidate energy/image gray-level mapping table T2 corresponding to the standard power value P2 as the predetermined energy/image gray-level mapping table. Then, the control unit 210 executes the firmware program FW to determine an energy compensation parameter A according to the standard power value P2 of the candidate energy/image gray-level mapping table T2 and the actual power value Pa of the TPH 202, wherein the energy compensation parameter A=P2/Pa. In this embodiment, since Pa is less than P2, the energy compensation parameter A is greater than 1 at this time. Next, the control unit 210 executes the firmware program FW to adjust the predetermined energy/image gray-level mapping table T2 according to the energy compensation parameter A in order to generate a target energy/image gray-level mapping table Tt. In the target energy/image gray-level mapping table Tt, an energy control value Wi′=A*Wi; in other words, the energy control value Wi′ will be greater than Wi under a condition of the same image gray level as shown in FIG. 8. Next, the control unit 210 executes the firmware program FW to drive the TPH 202 to print according to the target energy/image gray-level mapping table Tt. In this embodiment, the present invention method mainly utilizes the control unit 210 to execute the firmware program FW to control the output heating energy of the TPH 202 during the printing operation via controlling the turned-on and turned-off statuses of the switch 212. In this way, even under the condition of the actual power value Pa of the TPH 202 being less than the standard power value P2, adopting the adjusted energy/image gray-level mapping table can still make the TPH 202 generate a standard energy value corresponding to the standard power value P2. Similarly, when the actual power value Pa of the TPH 202 is closer and greater than the standard power value P2, it is also practicable to use the above method to tune the energy/image gray-level mapping table for controlling the TPH 202 to generate a standard energy value corresponding to the standard power value P2, and the detail is omitted for the sake of brevity.

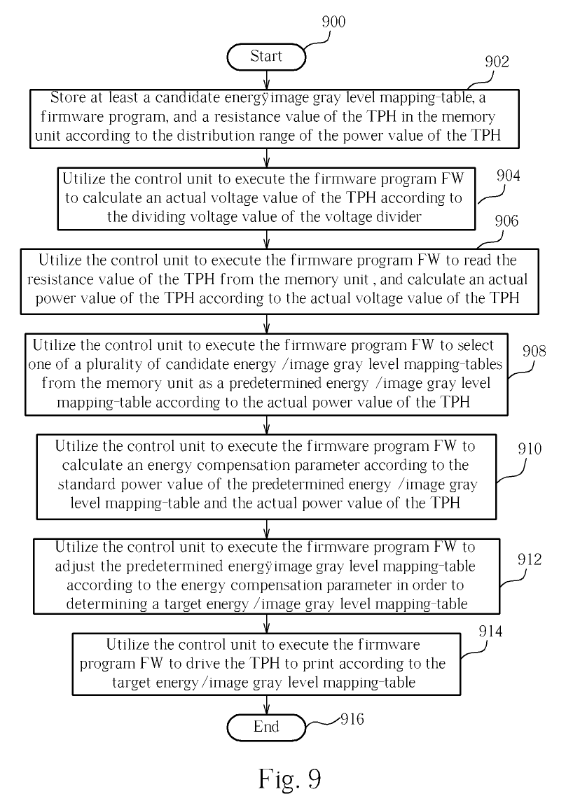

Please refer to FIG. 9. FIG. 9 is a flowchart showing an exemplary method for controlling output energy of a TPH according to an embodiment of the present invention. The operation of controlling the output energy of the TPH of the present invention is implemented with the thermal printing apparatus 200 shown in FIG. 2, and the flow can be summarized concisely in the following steps:

Step 900: Start.

Step 902: Store at least a candidate energy/image gray-level mapping table, a firmware program, and a resistance value of the TPH 202 in the memory unit 208 according to the distribution range of the power value of the TPH 202.

Step 904: Utilize the control unit 210 to execute the firmware program FW to calculate an actual voltage value of the TPH 202 according to the dividing voltage value of the voltage divider 204.

Step 906: Utilize the control unit 210 to execute the firmware program FW to read the resistance value of the TPH 202 from the memory unit 208, and calculate an actual power value of the TPH 202 according to the actual voltage value of the TPH 202.

Step 908: Utilize the control unit 210 to execute the firmware program FW to select one of a plurality of candidate energy/image gray-level mapping tables from the memory unit 208 as a predetermined energy/image gray-level mapping table according to the actual power value of the TPH 202.

Step 910: Utilize the control unit 210 to execute the firmware program FW to calculate an energy compensation parameter according to the standard power value of the predetermined energy/image gray-level mapping table and the actual power value of the TPH 202.

Step 912: Utilize the control unit 210 to execute the firmware program FW to adjust the predetermined energy/image gray-level mapping table according to the energy compensation parameter in order to determine a target energy/image gray-level mapping table.

Step 914: Utilize the control unit 210 to execute the firmware program FW to drive the TPH 202 to print according to the target energy/image gray-level mapping table.

Step 916: End.

Briefly summarized, the thermal printing apparatus and the method thereof of the present invention is able to stably control the output energy of the TPH during the printing operation under the condition of the actual power value of the TPH being unfixed. Since the present invention does not adjust the driving voltage of the TPH according to the resistance value offset of the TPH so as to maintain the actual power value of the TPH to the required standard power while the prior arts do, the mechanical variable resistor and the power converter are not required in the present invention. Thus, the present invention can solve the various disadvantages and problems caused by using the mechanical variable resistor and the power converter in the prior arts.

Those skilled in the art will readily observe that numerous modifications and alterations of the device and method may be made while retaining the teachings of the invention.

What is claimed is:

1. A printing method of a thermal printing apparatus, comprising:
storing at least a predetermined control mapping table, the predetermined control mapping table for recording control parameter settings of a thermal print head corresponding to different image gray levels under a predetermined power value;
calculating an actual power value of the thermal print head;
determining a target control mapping table according to the actual power value, the predetermined power value, and the predetermined control mapping table; and
driving the thermal print head to print according to the target control mapping table.

2. The printing method of claim 1, wherein the step of determining the target control mapping table comprises:
adjusting the predetermined control mapping table according to the actual power value and the predetermined power value to generate the target control mapping table.

3. The printing method of claim 2, wherein the predetermined control mapping table is a predetermined energy/image gray-level mapping table, and the step of adjusting the predetermined control mapping table according to the actual power value and the predetermined power value for generating the target control mapping table comprises:
determining an energy compensation parameter according to a ratio of the predetermined power value and the actual power value; and
adjusting the predetermined control mapping table according to the energy compensation parameter to generate the target control mapping table.

4. The printing method of claim 1, further comprising:
storing a resistance value of the thermal print head;
wherein the step of calculating the actual power value of the thermal print head comprises:
calculating an actual voltage value of the thermal print head; and
calculating the actual power value of the thermal print head according to the resistance value and the actual voltage value of the thermal print head.

5. The printing method of claim 4, wherein the step of calculating the actual voltage value of the thermal print head comprises:
generating a detecting voltage value according to an actual driving voltage value of the thermal print head;
performing an analog-to-digital converting operation on the detecting voltage to generate a detecting voltage value; and
determining the actual voltage value according to the detecting voltage value.

6. The printing method of claim 1, wherein the step of storing at least the predetermined control mapping-table comprises:
storing a plurality of candidate control mapping tables respectively recording control parameter settings of the thermal print head corresponding to different image gray levels under a plurality of candidate power values; and
the step of determining the target control mapping table according to the actual power value, the predetermined power value, and the predetermined control mapping table comprises:
selecting the predetermined control mapping table from the plurality of candidate control mapping tables according to the actual power value of the thermal print head.

7. The printing method of claim 6, wherein the step of selecting the predetermined control mapping table from the plurality of candidate control mapping tables comprises:
selecting a candidate power value closest to the actual power value from the plurality of candidate power values; and
selecting a candidate control mapping table corresponding to the candidate power value as the predetermined control mapping table.

8. The printing method of claim 6, wherein each candidate control mapping table of the plurality of candidate control mapping tables is an energy/image gray-level mapping table.

9. A thermal printing apparatus, comprising:
a memory unit, for storing at least a predetermined control mapping table, the predetermined control mapping table for recording control parameter settings of a thermal print head corresponding to different image gray levels under a predetermined power value; and
a control unit, coupled to the memory unit, for calculating an actual power value of the thermal print head, determining a target control mapping table according to the actual power value, the predetermined power value, and the predetermined control mapping table, and for driving the thermal print head to print according to the target control mapping table.

10. The voltage adjusting system of claim 9, wherein the memory unit further stores a firmware program, and the control unit executes the firmware program to calculate an actual power value of the thermal print head, determine a target control mapping table according to the actual power value, the predetermined power value, and the predetermined control mapping table, and drive the thermal print head to print according to the target control mapping table.
